(19) United States
(12) Patent Application Publication
(10) Pub. No.: US 2010/0193261 A1
(43) Pub. Date: Aug. 5, 2010

(54) Cost effective system for supplying solar electricity to both an extended range electric vehicle and a nearby building

(76) Inventor: Benjamin David Freeman, Philadelphia, PA (US)

Correspondence Address: Ben Freeman, 6045 Daniel St, Philadelphia, PA, 19144, US

(21) Appl. No.: 12/455,370

(22) Filed: Jun. 1, 2009

Related U.S. Application Data
(63) Continuation-in-part of application No. 12/322,565, filed on Feb. 3, 2009.

(51) Int. Cl. B60K 16/00

(52) U.S. Cl. 180/2.2

(57) ABSTRACT

The present invention is a system for supplying a long range electric vehicle and a nearby building with electricity from the sun in a cost effective way. Not only is the overall system totally efficient in the sense that virtually all solar electricity generated will be used, but the tilting solar roof that tracks the sun is a more efficient way to generate electricity than the normal method of putting stationary solar panels on the roof of a building or vehicle. Similarly, the car contemplated in the present invention will be able to achieve a far longer daily range than similarly priced electric cars. Because of the synergistic approach used, the overall system can play a significant part in weaning the world away from fossil fuels without creating huge costs that cash strapped consumers can't bear.

This application is a continuation in part of application Ser. No. 12/322,565 The title has been changed because of how the one major new feature and other minor changes radically improves the real-world value of the invention. The other changes in the claims, specifications and drawings are included to more clearly clarify the nature of the invention.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### SEQUENCE LISTING

Not Applicable

### BACKGROUND OF THE INVENTION

### Field of the Invention

Because of global warming and the coming oil crisis, the world needs electric cars. The world also needs a clean way to generate electricity for both cars and buildings. The only clean form of energy that is usable for both vehicles and buildings is solar energy. Hence, this invention is an electric vehicle whose oversized solar roof can supply most of the vehicle's electricity needs and a significant portion of the electricity needs of one's house as well.

Most electric utilities buy excess electricity produced by a house with solar generating capacity. Hence, this system avoids wasting electricity generated by the solar collection devices. If the car can't use it, the electricity is sent to the house. And if the house can't use it, the excess electricity is sent to the national power grid. Studies have shown that solar panels that track the sun can be 30% more efficient than those which remain in one stationary place. Hence, the sun tracking aspect of the present invention means that the total amount of electricity generated will be greater than would occur on a similar sized system place in a stationary position on the roof of one's home. Using a vehicle as the platform for a maximally efficient solar array whose electricity is almost never wasted makes it cost effective to mount a huge array on ones vehicle. In turn, an oversized solar array can provide enough electricity to power a vehicle for up to fifty miles per day. It is worth noting that both big car company designers and free lancers have generally found that a reasonably priced electric car cannot have a battery pack that can drive the vehicle much more than forty five miles without recharging. Considering also that solar energy is generated during the day while plug in electricity is generated during the night, the combination of using both plug in electricity and a large solar array creates a constant flow of energy to the vehicle. It can also double the de factor daily range of a reasonably priced electric car. Since there will be a constant flow of energy, the size of the energy storage system (generally batteries) will be radically reduced and far less expensive than the energy storage system of a regular electric car that has an equal range based on being charged once a day. This means that a cost effective solar electric car can achieve daily ranges far greater than the average driver uses with a minimal battery array size. This is important because the weight, cost, size and dangers associated with large battery arrays are the prime reason that electric cars aren't the dominant mode of transportation today. Hence, this system of using a huge solar array on a vehicle will make electric vehicles viable and provide a reasonably priced source of electricity for a significant percentage of the home's use.

While oversized solar panels on a car is the key necessary pre-condition to generating a significant percent of a cars power through the use of solar panels, there area many other considerations associated with an electric car to make it salable to a large percentage of car buyers. The most important and difficult problem for all types of electric cars to overcome is that one usually can't continuously travel any further than the battery pack will allow. While some hope that the range issue will be solved by the invention of a method for fast charging batteries in minutes, there is no research which suggests that it will be possible for an electric car's batteries to be recharged in a few minutes. The huge solar array featured in the present invention may allow one to travel up to twice as far as the maximum range of the battery pack, but only when the range is figured on a daily basis.

To make it possible for electric and solar electric cars to travel further than the battery pack would allow within a few hours, a dense network of battery exchanging and recharging stations could eventually be built. Hence, a car of the future will be built for easy battery exchange even while the network of battery exchanging stations is only a conceptual possibility. To make it unnecessary to do major engineering changes once the battery changing stations exist, this vehicle is designed for an easy exchange of batteries

It is also worth noting that one must have certain controls and measuring devices to

To create the effect of having a solar roof far larger than the car which can be driven on regular roads, the present invention would work best with a thin vehicle. A reissued US patent given to Mr Desert (number 31156) focuses on a very thin vehicle. However, this patent seems to be aiming at a long, almost buslike, vehicle. Such a large vehicle would not be able to use a lower horsepower and lower amp draw motor because it would weigh so much. Further, it would never fit into a standard parking space. Most importantly, this patent never made the additional suggestion to use the extra space along the sides of a thin vehicle for solar panel overhangs.

There are patents which use trailers as platforms for generating electricity. While none of them includes more than one of the various elements which allow the present invention to sprout a huge array while it is parked in a safe and viable way, there are a handful that each contain something similar to one of the key elements of some of the optional (dependent claims) of this patent application. For instance, U.S. Pat. No. 5,542,203 by Luoma et al and U.S. Pat. No. 6,960,717 by Stuart suggests the use of a tube within a tube that has the effect of raising and lowering the solar panel. Although the telescoping systems in these two patents are different from that contemplated in the present invention and aren't fully applicable for a vehicle that is being driven, they are similar in a general way to one element of one off the two embodiments of this patent application. At the same time, U.S. Pat. No. 5,969,501 by Glidden, involves a trailer where solar panels mounted on the roof and sides can be raised and lowered. While the exact system depicted in his drawings would be unworkable, unsafe and be prone to being damaged in accidents if it were used on a car or van, this patent generally suggests the idea of moving panels around to reduce or increase the size of the solar array as per one of the two embodiments of my invention. While the patents to Glidden and Luoma Jones disclose some of the elements of our proposed solar array retraction system, they do not even involve a vehicle intended to be used on roads. Partly for this reason, they are lacking all of the other key elements of the present invention.

The patent or patent pending which is probably closest to the present invention is US 2006/012128162 by Saelzer et al. It does include a tilting solar roof. But because the roof is no larger than the vehicle body, it cannot supply enough electricity to run the vehicle. Since it doesn't even supply enough electricity to run the vehicle, it doesn't include our key idea of sending excess electricity to a nearby building. Nor does it include most of the other key features of the present invention.

While there are both patents and actual example of solar panels whose electricity can be used inside a building rather than by the platform on which they are mounted, there is no patent or actual example of a vehicle intended to be used for transportation on roads which uses solar panels and sends the excess electricity to a nearby building.

Especially in regard to a synergistic system which supplies non-fossil fuel power in a cost effective way to both a vehicle and a nearby building, a whole variety of interconnected, controls, measurement devices and other related mechanisms are needed if one wants to optimize the practicality of the system. None of the patents on solar systems include all the key controls and devices required to maximize the energy output, know when the vehicle is about to run out of power and minimize wasted electricity.

Because no dense network of battery exchanging stations yet exists, I only include the easily exchangeable battery array as a dependent claim (option). Nonetheless, I consider it a key element of the car of the future and this present invention because the ability to exchange depleted batteries for fully charged batteries is necessary to allow an electric or solar electric car to go about as far in one day as a car or van with an internal combustion engine. In effect, an inexpensive battery exchanging system would create the same effect as filling up the gas tank of a car with an internal combustion engine. With this in mind, it is worth noting that there is no patent, published paper or existing system anywhere relating to a solar car with an easily exchangeable battery array. Instead there are a few overly complex conceptual ideas for exchanging batteries. Fir instance, published U.S. Pat. No. 5,951,229 (inventor Hammerslag) describes a battery charging and transfer system for electrically powered vehicles. Not only is it too high tech and complex to be produced at a reasonable price, but the mechanism required takes an enormous amount of space. Hence, building cars designed to accommodate this battery exchanging system is a dead end because the battery exchanging stations will have to charge so much that consumers would find it less expensive to buy and use a car with an internal combustion engine.

Another example of an overly high tech and expensive to implement idea related to some of the components of the present invention is provided by U.S. Pat. No. 3,971,454 (Waterbury). It depicts a vehicle whose large output of solar electricity partially relies on converting high intensity sunlight into electricity. While this is a good idea that I include as a dependent claim, the complex supportive infrastructure contemplated in Waterbury's patent does not exist. Even if it did, the cost of making each vehicle using the system contemplated in that invention would e far higher than the average family could possibly afford. Furthermore, it lacks all the other key features of the present invention.

Especially if one goes down far enough to analyze individual components and sub-components, there is nothing new under the sun. Another reason that no individual feature of the present invention is totally different from something which already exists is that the point of this invention is to generate the unexpected end result of lowering the cost of solar electricity to make it affordable for the average family. Since simple and “off the shelf” components are almost always cheaper than complex and unique ones, it is to be expected that none of the components of the present invention are especially unique or complex. The unexpected end result is a function of the synergy created by combining the many low and moderate tech “off the shelf” features to create an affordable system.

The human race's march towards catastrophic global warming and an oil crisis is not rooted in our lack of knowledge regarding how to build solar electric vehicles, electric vehicles or how to generate electric power for buildings from clean sources of power. Nonetheless, solving the problem requires us to implement cost effective ways to switch over to clean and green sources of power for billions of homes and buildings. The value of the present invention is that it converts electric cars and the use of power to help generate electricity in buildings from expensive toys into a cost effective and practical way for the human race to mitigate global warming and prevent the world's oil supplies from quickly running out. Since accomplishing these two objectives in a cost effective way might literally make the difference between survival and catastrophe for our global civilization, we can see that the synergistic approach manifested in this patent application has great value.

Precisely because of the importance we put on survival of our civilization and the profits that could be made if a vehicle could go a long way towards solving these problems, many teams of well funded engineers and other experts, along with huge numbers of individuals, have been looking to develop an invention that fulfilled these objectives. Since none of these well funded teams or passionate individuals have come up with another alternative which is nearly as cost effective as the one contemplated in the present invention, it must not be obvious to a person (or even a team of persons) with a reasonable appreciation of the relevant art how different, and comparatively simple and well known, components can be combined to create a synergistic system whose real world value is far greater than the sum of its parts.

### BRIEF SUMMARY OF THE INVENTION

The present invention is an extended range solar electric car whose excess solar power can be used to provide electricity to a nearby building. It is only because it combines all of the following groups of features that it can create the unexpected effect of being a practical and cost effective way to radically reduce fossil fuel use for huge number of individuals and families:
1 The ease of egress, safety and potential speed that is characteristic of vehicles seen on the roads and highways of today.
2 Has an electric dive motor which is directly supplied by an energy storage system (normally batteries) so that the vehicle can run when its active power generation systems are not producing any power.
3 Despite the need for an energy storage system, its cost and weight must not be so great that they make the vehicle overly heavy or overly expensive.
4 The ability to convert solar energy into the electricity required to drive the vehicle and to “plug in” the vehicle to a nearby electric system to supplement the power coming from the solar collection devices. The combination of “plug in” and solar power is especially useful because one generally “plugs in” a vehicle at night while solar electricity is only generated during the day. Hence, this combination creates the constant flow of electricity which allows for the comparatively light battery pack as described in number 3 above.
5 For the solar roof to generate enough electricity to make a significant contribution to the vehicle's total energy needs, the solar roof must have a normal footprint larger than the footprint of the vehicle.
6 The solar roof must be mounted on top of the vehicle in such a way that it can move, tilt and, possibly retract, to maximize power generation while avoiding hitting people, objects or other vehicles.
7 To guarantee that the solar power is not wasted during the days when the vehicle isn't being driven far, the solar roof must be able to send its excess electricity to nearby buildings when its energy storage system is fully charged.
8 The vehicle and the nearby building it is associated with must have a system of controls, measuring devices, transforming devices and monitors which allows the driver to avoid running out of electricity, to avoid wasting energy, to maximize energy output, to have an ease of egress and to redirect power from the vehicles energy storage system to a nearby buildings energy needs when the power is no longer needed by the vehicle.

In fact, no other invention or existing car, truck, bus or van combines more than two or three of these eight over-riding features. This is why none of them could be cost effective even if solar generation systems produced significantly more electricity at a lower price. Not only are the existing designs for solar vehicles which only include a few of our features far too expensive and/or difficult for regular use, but even combining half of these eight features would not create a system anywhere close to cost effective in the foreseeable future. It is only by combining all of the groups of features listed above that we create the unexpected end result of making a practical car that uses no oil, gets most of its electricity from the sun and is also cost effective. For the drivers that want a green car but need to travel further than an electric car can travel, one can combine the eight features listed in this section with a supplementary gas engine.

While the key to generating enough electricity to provide a significant percent of a car's power is to make the car as small as possible and the solar array as large as possible, a practical car must be large enough to fulfill the cargo and passenger requirements of its buyers. All things being equal, therefore, the main way that one maximizes the amount of driving miles created by the solar array is to make it as large as possible. But, of course, one cannot easily drive a car if the footprint of its solar array is much larger than the footprint of a large existing van. This is because customary driving patterns and the way roads are built would mean that the huge array would often hit other cars, pedestrians or other objects. Furthermore, driving a vehicle with an overly large array on windy days could create a form of lift-off like an airplane that would also cause accidents.

Hence, there are basically two variants of the oversized array which is probably the most important individual feature of the present invention. If the car size was minimized to be no larger than the smallest car on the market and the footprint of the array was as large as the largest van or small truck, then we could achieve our result with an array that could remain at its fully deployed maximal size whether the car was being driven or parked. As you will see as you read the more detailed description with reference to the drawings one through five, this type of vehicle would also have the advantage of creating a unique safety perimeter that would significantly reduce the danger that side impact collisions would cause serious injuries or death to the driver or passengers.

But one could also build a vehicle with a more extremely oversized solar array under two conditions. Firstly, the solar array must be retractable when the car is being driven and only fully deployed when the car is parked. Not only are all cars parked more than they are being driven, but the type of driver who could buy any form of electric car generally drives a smaller percentage of the time than an average driver. Therefore, this more extreme version of an oversized solar roof could be practical for many buyers and produce solar electricity during most daylight ours. The second condition required to make such a car practical is that it must be possible to raise the solar array at least three feet above the normal car height when it is fully deployed. This extra height is necessary so that people can walk under it and nearby parked cars would not be hit even if the array were slightly tilted towards the sun. Not only would this second embodiment look more like a “normal” car or van when it is being driven, but it could have more room for passengers and cargo. It is with this in mind that one can understand the more detailed description with reference to figures six through nine.

Until a dense network of battery exchanging systems exist, people who feel that they need the car to drive long distances will still need a secondary type of engine to supplement the electric motor. But as compared to existing hybrids or the type of modified hybrid that does not have solar panels but does allow for a plug in capacity, a hybrid which incorporates the eight key features which constitute the heart of the present invention would be far better for mitigating global warming and noticeably better in terms of preventing the coming oil crisis. To understand the ecological advantages of a hybrid incorporating the key eight features of the present invention, one must realize that a plug in hybrid is till getting most of its plug in energy from fossil fuels and a regular hybrid is really getting much of its electric power as a byproduct of the use of its internal combustion engine. On the other hand, a solar electric hybrid with our proposed eight features would be getting a large percentage of its energy directly from the sun—and simultaneously providing a significant amount of energy to the owners' home or other building where it is normally parked.

In all embodiments of the present invention, at least one of the wheels receives power from the prime mover, normally an electric motor that produces torques and moves the car against the frictional resistance between the wheel and the driving surface. The solar vehicle which is the heart of the system created by the present invention would typically feature regenerative braking which creates energy as it slows the car down. To maximize safety, however, regular braking will also be provided whether or not one used regenerative braking.

Both sets of dependent claims of the present invention and the detailed description of the drawings incorporate the idea that the batteries will be placed for easy removal. The reasons for this are explained in the background section of this patent application. The goal of easy battery removal can be accomplished by setting the batteries on a tray placed in the very back of the vehicle. The tray, in turn, will be set on the car body in such a way that the types of tynes used in forklifts can remove the entire tray with the batteries still affixed to the tray. The primary point of doing this is to allow for a discharged energy storage (or battery) array to be replaced quickly with a fully charged one affixed to an identical tray. This would allow the driver to continue on their way in the same way that a driver can fill his tank with gas and continue on his way. Obviously, the electric connection between the batteries and the remainder of the car must be set up so that a non-electrician can easily disconnect them when a discharged battery array is being removed and then reconnect the newly installed fully charged battery array to the car's electrical system.

In addition to the oversized solar roof, one could also put a solar panel on the hood of the car. Since the oversized roof array may sometimes shade the hood array, one cannot electrically connect the hood array to the roof array because doing so could shut the whole system off when the hood was being shaded. But the hood array could generate electricity independently of the main array. This electricity could be used to power the auxiliary systems. This makes practical sense because the auxiliary systems generally run at the lower voltages which the smaller hood array would typically generate. On the other hand, an electric vehicle motor and a building operate at the higher voltages that a much larger solar roof array would more typically generate.

As you may have noticed, I use the words “solar panel” and “solar energy collection devices” almost interchangeably. That is because this same system would work just as well if one used a solar collection device (for instance the paint or thin film devises that are just now coming to market) that is not designed exactly like today's solar panels. Similarly, I use the word “battery” and “battery array” when I technically mean “electricity storage system.” While most types of electricity storage devise and systems might work, I often use the word battery because that is the best known type of electricity storage device.

I believe that the combination of features included increases the range of the vehicle without creating a car whose weight, cost or difficulty of using and repairing creates more total disadvantage than a gas driven car. Although the controls, recharging and other features make it slightly more difficult to use than a car with an internal combustion engine, the lowered amount of parts and repair costs (electric cars have far less parts than cars with internal combustion engines) will compensate. In the end, the maintainence and other difficulties associated with owning an all electric version of our car will usually be about the same in total as the maintainence and other difficulties associated with owning a gas driven car. Especially if one assumes that a network of battery changing stations will eventually be built as many are already planning for, these features convert an electric car from a specialty vehicle for those who only drive short distances or who are willing to spend large sums of money for purely moral purposes into a practical cost effective vehicle. Even before a dense network of battery exchanging systems exist, the combination features included in the present invention makes it possible to build a uniquely green affordable car for a family's second car for use by those who only rarely travel more than seventy miles per day. Furthermore one could build a hybrid version of this vehicle with a secondary source of power for those who regularly travel long distances or as a family's first car.

While any vehicle is designed to offer mobility on the days when the owner wants to go twenty or more miles, there are many days when people don't drive their cars or only drive them a few miles. During those days, a solar car with an oversized solar array but without a way to transfer excess energy to a nearby building would waste most of the solar energy created by the solar array. It is with this in mind that the ability to feed excess solar power back into one's home becomes a crucial way that the present invention does not waste energy and, therefore, remains cost effective. Hence, the present invention is really a system for powering both ones' vehicle and ones' home.

### BRIEF DESCRIPTION OF THE DRAWINGS

FIG. 1: is a side and rear view of the vehicle with a safety perimeter and a solar roof that does not change in size and can only move in one direction.

FIG. 2: Is a side view of the vehicle which also shows the front with a safety perimeter and a solar roof that does not change in size and can only move in one direction.

FIG. 3: This is a view of the vehicle with the top taken off. It was included primarily to make it easier for a reader to see how a safety perimeter which provides some real protection from side impact collisions could be integrated with the other key features in the present invention.

FIG. 4: This is a rear view of the vehicle. Its purpose is to highlight the battery exchange feature.

FIG. 5: This is a wider angle view of the vehicle and the nearby structure with the electric lines and related machinery carrying electricity from the house to the vehicle when its batteries are depleted. It also shows how the excess electricity created by the solar panels can be carried to the house when the car energy storage system (batteries) are fully charged.

FIG. 6: This is a side view cutaway (meaning the outer skin is taken off) of the vehicle with a maximally sized solar roof in its normal position.

FIG. 7: This is a side view of the same vehicle with the outer skin included.

FIG. 8: This is a side view of the vehicle with a maximally sized solar array while it is retracted and its six component parts are stacked one on top of the other.

FIG. 9: This is a side view of the vehicle with a maximally sized solar array while it is partially retracted.

### INDEX OF DRAWING REFERENCE NUMBERS

1: Body of the car
2: The energy storage system used to power the motor, generally batteries
3: Rear door which is generally used to access the energy storage system (2 above)
4: Accessory battery
6: Drive Motor
7: Pedal which the driver uses to control the controller number 8 below
8: Motor controller which determines the amount of power being used by the drive motor
10: Wheels
12: Seats
14: Solar Roof
16: Hood Solar Panel
20: Support for solar roof when it opens on one axis
22: Sensor display for driver to see whose most important function is to let the driver know how much further s/he can drive without recharging the batteries. The best way to do this would be to show the charge level of the batteries and then translating that into miles remaining on the existing battery charge.
24: Wireless communicator for controlling solar panel position from outside the vehicle. The primary value of doing this with a wireless communicator is to avoid forcing the driver to assume contorted positions for egress and to move the solar panels when the car is parked and the driver is not in the vehicle. The amount of current generated by the solar roof should also be displayed here (rather than in number 22) since the driver would want to know how well the vehicle is charging when s/he is not sitting in the vehicle to alert him or her when it is necessary to change the solar roof position.
28: Windshield
30: Slots for forklift type tynes to fit in
32: Side bumper as part of the safety perimeter of one embodiment of this vehicle
34: Location of sensors to activate the external air bags and a possible location for the air bag itself. These combine with the bumper to illustrate how the idea of a safety perimeter suggested in the claims would manifest itself in an actual vehicle.
36: A solar array controller which averages out spikes in solar electricity to convert electricity into usable form for the batteries or nearby building and which automatically shunts electricity generated by the nearby building when the batteries are fully charged.
38: Driver
40: Electric Line coming from nearby building to feed the battery
42: Electric line coming from the solar array to feed the nearby building's electricity's electrical system.
44: A lift system which raises the inner tube of the mast system. Another way to say this is that the space of number 44 is the place where the mechanical or hydraulic devices go to move the inner tube (48) upwards in the outer tube (46) and which collectively create a telescoping mast.
46: Outer tube of the lift system.
48: Inner tube of the lift system.
50: A maximum sized solar array when it is in its normal deployed position.
52: The same solar array as in number 50 when it is retracted and lowered and the individual panels which comprise it are stacked one on top of the other.
54: The mechanized hinge which could be used to help open the three panels that make up each half of the solar array
56: the mechanism that could slide the two halves of the solar array apart and which could tilt the solar array.

### DETAILED DESCRIPTION OF THE PRESENT INVENTION WITH REFERENCE TO THE DRAWINGS

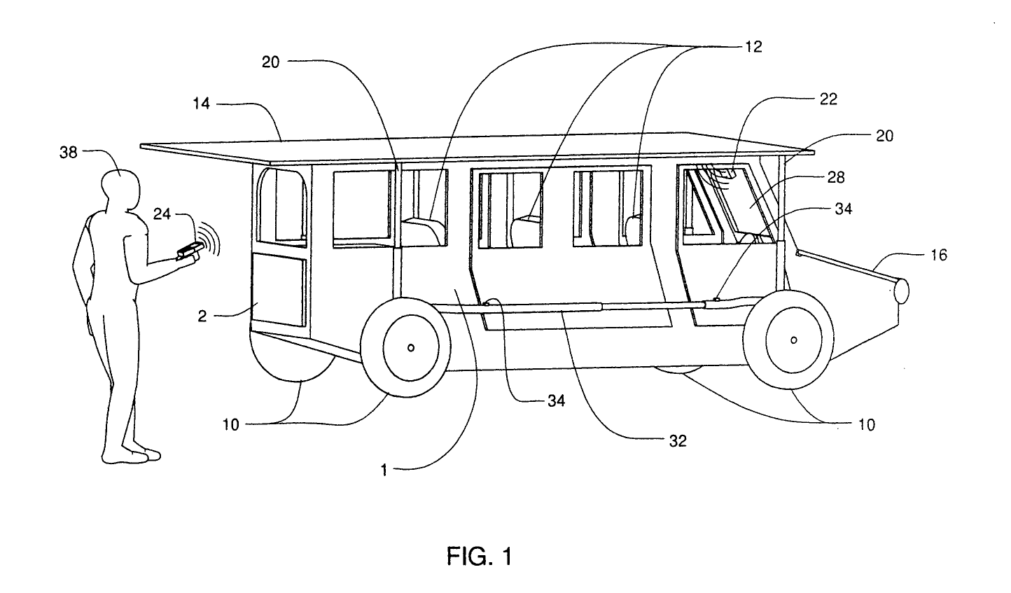

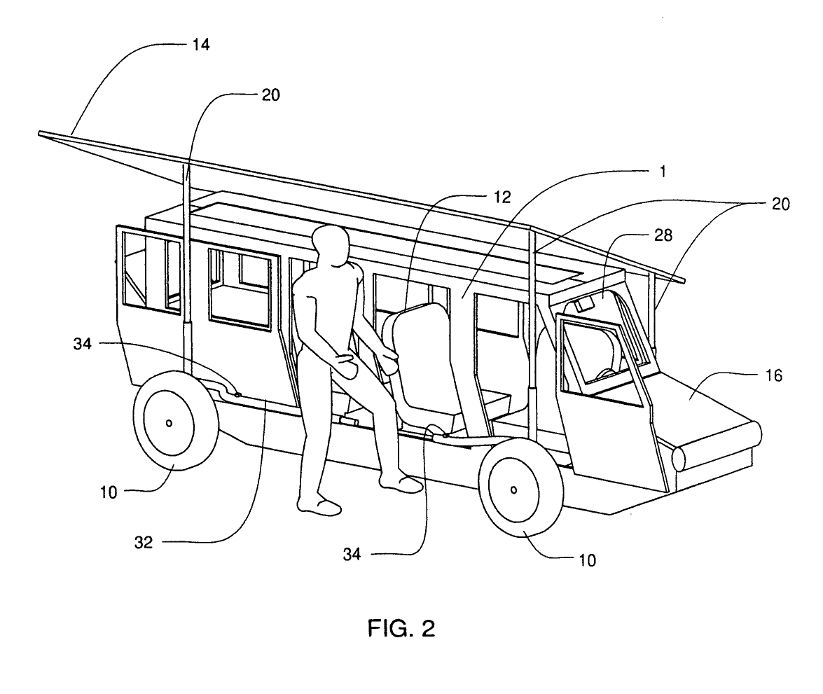

Referring to FIGS. 1 and 2, the body 1 is supported by the four wheels 10. Located where a hood would normally go on the body 1 is a hood solar panel 16. Located on the roof of the body 1 is the type of solar roof that cannot be made smaller or larger 14. Located near the front of the body 1 on the inside near the top of where the windshield 28 is located are the sensor displays 22. Figure one (but not FIG. 2) also depicts how the sensor displays 22 can be wirelessly accessed by the communicator 24 that the driver 38 is holding. Between the wheels 10 are side bumpers 32. Mounted on the side bumpers are sensors 34 to tell if the vehicle has suffered a side impact collision which could set off outside air bags. The space referred to as 34 could also be where the side impact air bags are mounted. Coming up from the side bumpers 32 are supports 20 which connect with and help support the solar panel roof 14.

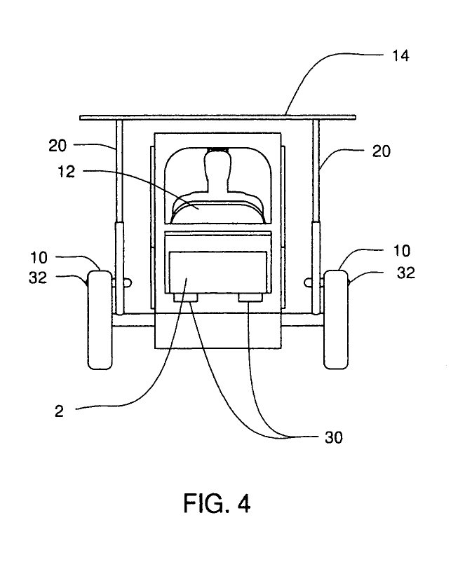

As you can see by comparing the different length of these four supports 20 in FIGS. 1 and 2, they can move up and down. Those on one side of the vehicle move upwards as those on the other side of the vehicle move downwards. Hence, the effect of moving them up and down is to change the angle of inclination of the solar roof 34 as can also be seen by comparing the different position s of the solar roof as depicted in the same two figures. The other reason to be able to raise and lower one side of the solar roof 14 is to allow ease of egress by letting a rider or driver enter the vehicle when the solar roof 14 is raised on the same side that they wish to enter. The methodology to raise and lower these four telescoping masts is more clearly depicted the three figures (6, 7 and 8) which depict an extreme version of the oversized solar roof which only has one larger telescoping mast. Also depicted on FIG. 1 is the back door for access to the battery array as shown more clearly in FIG. 4.

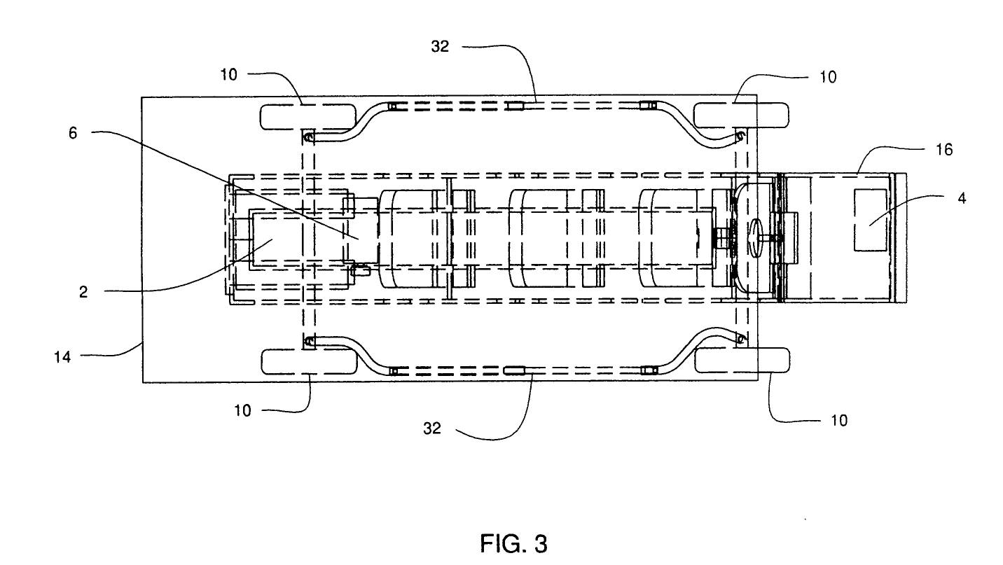

Because FIG. 3 is a top view of the vehicle with the roof and solar array removed, we can better see the way that the safety perimeter protects the car from side impact collisions. As you can see, the side bumper 32 is a noticeable distance from the outside of the body of the vehicle. Hence, there would be some time for an outside air bag to deploy when the outside sensors 34 are hit by an incoming vehicle during a side impact collision.

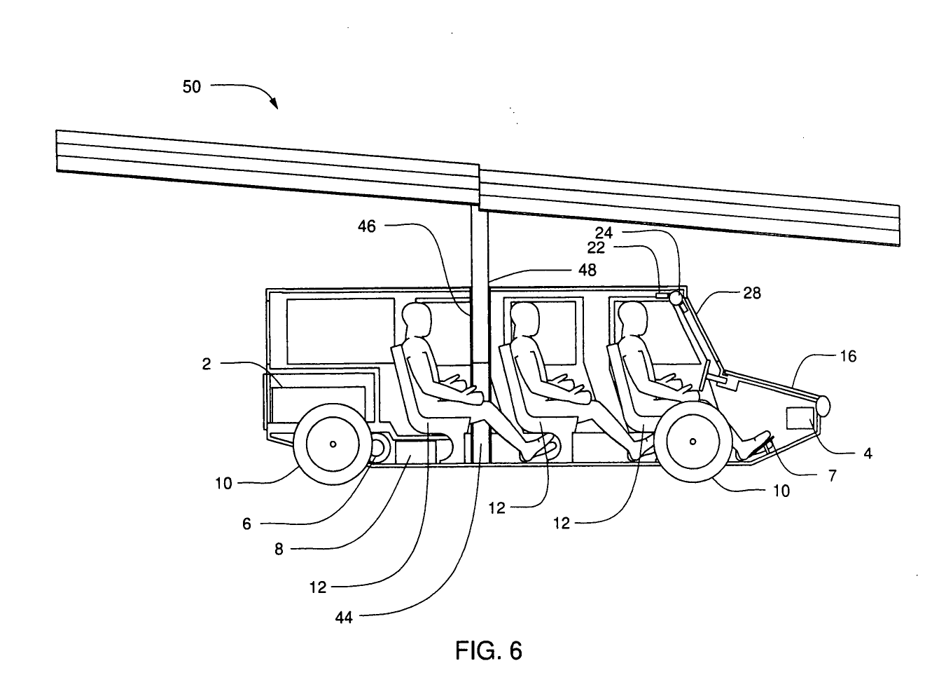

FIG. 4 helps one see how the easy battery removal system could work. The tynes of a forklift type device would go into the slot 30 and go under a depleted energy storage system array, or under the sheet of metal or other material on which the batteries are mounted. Then the tynes of the forklift type device would remove the depleted batteries and replace them with an identical, but fully charged battery array. Once this is done, the vehicle could continue on its way the same way a car with an internal combustion engine continues on its way after its gas tank is refilled. This view also makes it easier to imagine how the inner and outer tube for the support struts 20 holding up the solar panel also acts like a telescoping mast to raise and lower each side of the solar array when required. It will be even easier to understand how a telescoping mast works on the vehicle when one looks at FIGS. 6, 7 and 8.

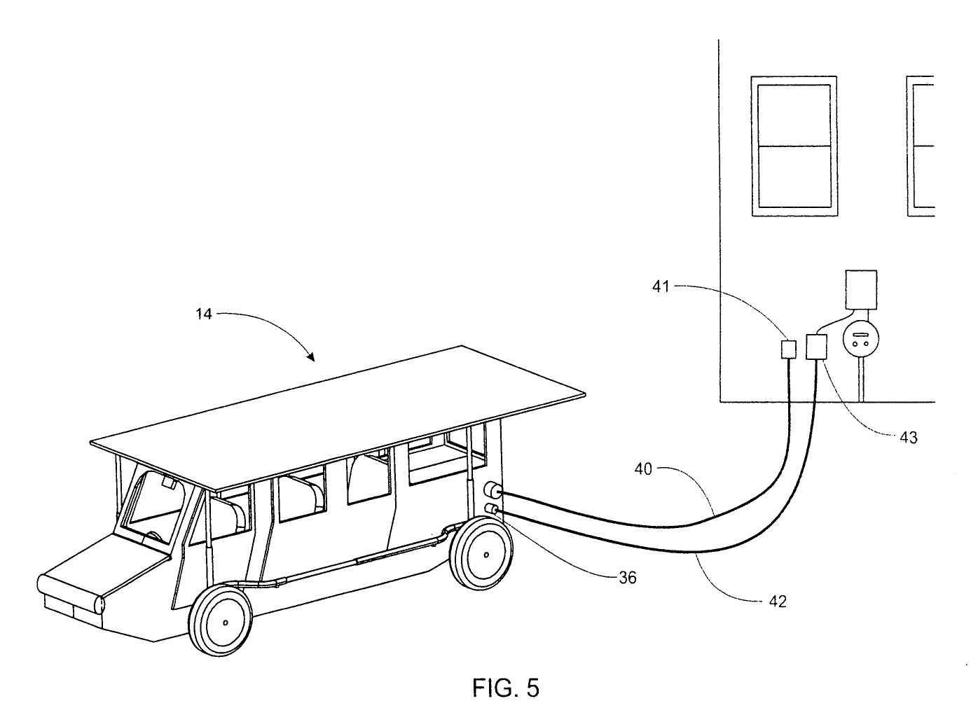

FIG. 5 exists to help one see how the overall electrical systems (both the batteries and the solar array 14) of the car and nearby building (house in this case) interact with each other. When the energy storage system is low, charger 41 could charge the batteries 2 (not seen because they are inside the car) by sending electricity from the building to the batteries 2 using electrical line 40 after the charger 41 has converted the house AC electricity to DC electricity as needed in the vehicle. The solar array 14 will also be using the electricity it generates to charge the batteries 2 if they are not fully charged. When the batteries 2 are fully charged, the electricity generated by the solar array will redirect itself to the house through the wire 42. Before the electricity gets into the house, an inverter 43 will convert the DC from the solar panel to the AC needed by a building. Before the electricity from the solar array goes to the nearby building or to the batteries, it will go through the solar controller 36 which evens it out and configures it in a stable voltage so it can be used without damaging either the vehicle batteries 2 or the electrical system of the nearby building. Additionally, it is this solar controller 36 which automatically diverts the solar electricity generated from the batteries to the nearby structure when the batteries 2 are fully charged.

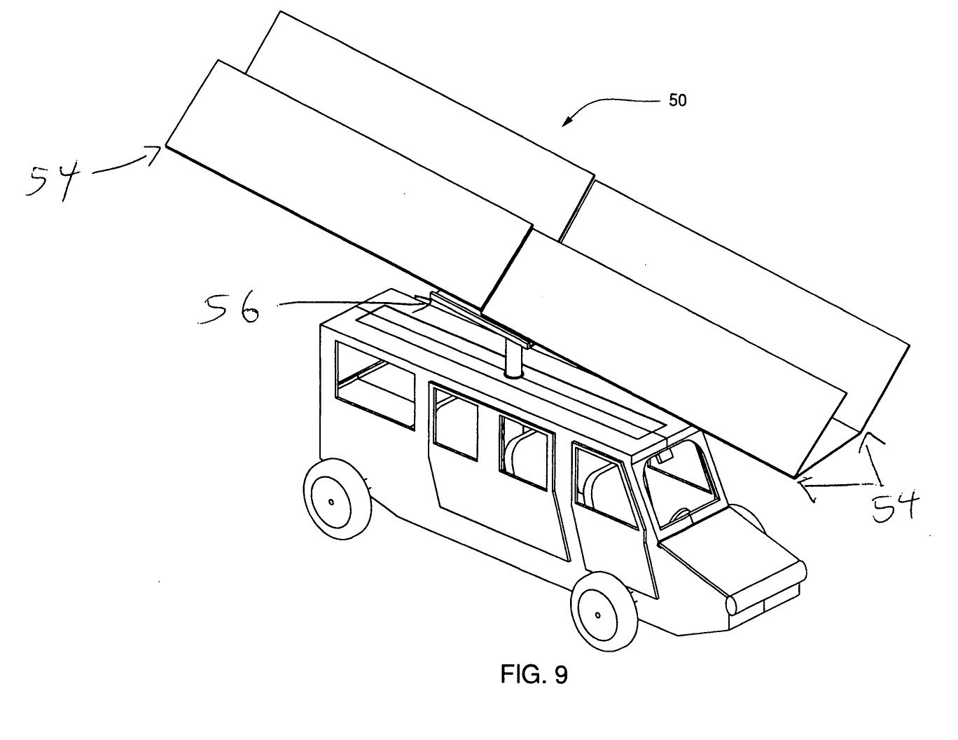

FIG. 6 is a cutaway view of the side of the vehicle which features a solar array 50 so large that it must be retracted while the vehicle is driving in order to avoid hitting other vehicles. In this figure, number 46 is the outer tube of the telescoping mast and number 48 is the inner tube. It is the inner tube 48 which actually attaches to the solar array and is made to tilt it using a ball or other type of mechanism at the top (see FIG. 9). FIG. 44 depicts the area occupied by the mechanism or hydraulic system that raises and lowers the inner tube 48. As you can see, the outer tube 46 touches and is affixed to the bottom frame of the vehicle. When it is in its normal deployed position as pictured in FIG. 6, the way oversized solar array 50 can be a few feet above the top of the vehicle so that the extended array won't hit nearby parked cars or people. It is also worth noting that this figure depicts the foot pedal 7, which the driver uses to tell the motor controller 8 how much energy it should feed into the drive motor 6.

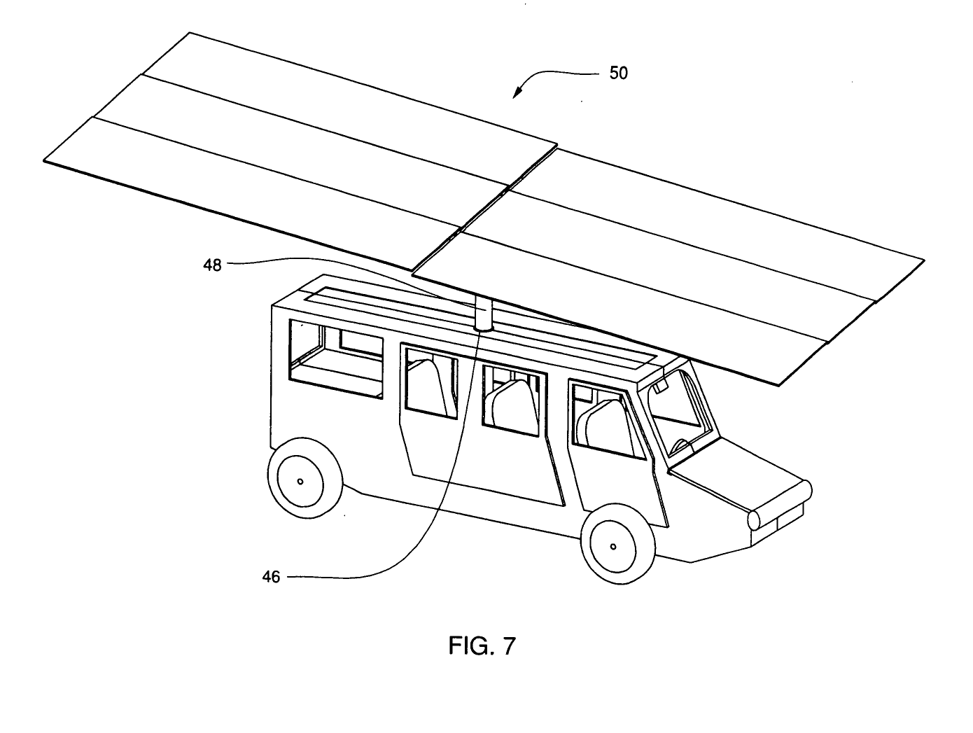

FIG. 7 is the same vehicle seen from the other side without the outer skin being peeled away. It depicts nothing that isn't depicted in FIG. 6 or in other drawings.

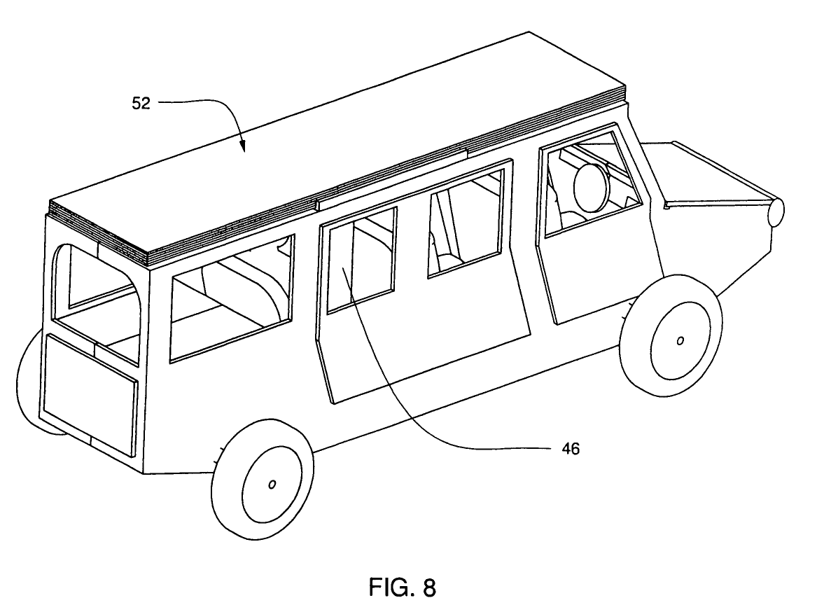

FIG. 8 shows the same vehicle with the solar array retracted and divided up into six component parts stacked one on top of the other (collectively they are the solar array 52). Of course, the number of component solar panels which collectively make up the larger solar roof is not fixed at six. It could be more or less, partly depending on how extremely large one wants to make the solar roof.

FIG. 9 shows the same vehicle with the solar array 50 partly retracted. The purpose of this is to illustrate one way that the retraction and tilting system of the claims could work. As you can see, the particular system used as an example for the purpose of these drawings is composed of six panels in two groups of three. FIG. 56 is the mechanism used to divide the six panels into two sets of three, to stand up on top of the telescoping mast, help support the solar array 54 and to tilt the array 54 when required. FIG. 54's most important component is the mechanized hinge points that open out each set of three previously stacked solar panels into one much larger solar energy collection device.

The most common methods used to retract the solar roof into its component panels would be a combination of sliding and hinging. However, which specific retraction method to choose really depends on a variety of factors such as the overall size of the solar roof, the number of solar panel components and the methodology used to tilt the solar roof An alternative way to tilt the solar roof might be based on a ball or a spider like mechanism at the interface between the solar roof 54 and the telescoping lens.

I claim:

1. A system for supplying energy to an extended range solar vehicle and a stationary structure comprising:
a vehicle body;
three or more wheels for supporting the vehicle body;
at least one prime mover, with a control system, supplying energy to at least one of the three or more wheels;
one or more energy storing devices for supplying energy to the at least one prime mover;
a solar collection assembly of one or more solar collecting devices which converts light energy into electrical energy;
an indicator for monitoring the energy being generated by the solar collector assembly;
an indicator for monitoring the energy being stored in the energy storing device;
a two-way energy transfer system providing a plug-in recharge to at least one of the one or more energy storing devices and for supplying energy from the one or more solar collecting devices to the stationary structure
wherein the outer width of the solar collector assembly exceeds the width of the vehicles body measured normal to the direction of vehicle travel

2. The system of claim 1, wherein:
The solar collector assembly is adapted for facing the position of the sun or moving out of the way of shade, people and objects by tilting about one axis normal to the direction of vehicle travel.

3. The system of claim 2, wherein:
A wireless device controls the tilt of the solar collecting assembly out of the way of people, shade or objects or to better align the solar collecting device with the sun.

4. The system of claim 3, wherein:
A distance between at least two of the three or more wheels exceeds the width of the vehicle body to reduce the aerodynamic effects of the solar collector assembly during vehicle movement.

5. The system of claim 4, wherein:
The solar collector assembly exceeds the width of the body by at least 30 percent.

6. The system of claim 5, wherein:
The total area of the solar collector assembly exceeds the area of the footprint of the vehicle body.

7. The system of claim 6, wherein:
Energy is recovered from braking the wheels with a regenerative brake system.

8. The system of claim 7, wherein;
The energy storage devices are adapted mechanically and electrically for rapid exchange.

9. The system of claim 8, wherein: there is a safety perimeter external from the body.

10. The system of claim 9, wherein:
The solar collector assembly converts both light and thermal energy from solar energy into electrical energy.

11. the system of claim 1, wherein:
The solar collector assembly is adapted for facing the position of the sun or moving out of the way of shade, people and objects by tilting about two axises normal to the direction of vehicle travel.

12. The system of claim 11, wherein:
Raising and lowering of the solar collector assembly is accomplished by a telescopic mast.

13. The system of claim 12, wherein:
The solar collector assembly retracts to a reduced length and width to reduce aerodynamic effects of the solar collector assembly during vehicle movement.

14. The system of claim 13, wherein:
The solar collector assembly exceeds the width of the body by at least 30 percent

15. The system of claim 14, wherein:
The solar collector assembly exceeds the length of the body.

16. The system of claim 15, wherein:
The total area of the one or more solar collecting devices exceeds the area of the footprint of the vehicle body.

17. The system of claim 16, wherein:
Energy is recovered from braking the wheels with a regenerative brake system.

18. The system of claim 17, wherein:
The energy storage devices are adapted mechanically and electrically for rapid exchange.

19. The system of claim 18, wherein:
Controlling of the telescopic mast and of the opening, closing and tilting of the solar collector assembly out of the way of people and objects and to better align the solar collective device with the sun is accomplished by a wireless device.

20. The system of claim 19, wherein:
The solar collector assembly converts both light and thermal solar energy into electrical energy.
